(19) United States
(12) Patent Application Publication
(10) Pub. No.: US 2026/0349761 A1
(43) Pub. Date: Nov. 5, 2026

(54) METHOD AND APPARATUS FOR CACHING LAYOUT PARAMETER, DEVICE, MEDIUM AND PROGRAM PRODUCT

(71) Applicant: Bytedance Technology Ltd., Grand Cayman (KY)

(72) Inventor: Xiangdong LIU, Beijing (CN)

(21) Appl. No.: 19/664,734

(22) Filed: Apr. 30, 2026

(30) Foreign Application Priority Data
Apr. 30, 2025 (CN) 202510571258.5

(51) Int. Cl. G06F 9/451; G06F 3/04847

(52) U.S. Cl. CPC G06F 9/451; G06F 3/04847

(57) ABSTRACT

Embodiments of the present disclosure provide a method and an apparatus for caching a layout parameter, a device, a storage medium, and a computer program product. The method includes determining, in response to a request for a layout parameter setting for a first control, whether a layout parameter cache for the first control is present. The method further includes determining, in response to the layout parameter cache being present, whether the layout parameter of the first control needs to be set according to the layout parameter cache. The method further includes cancelling, in response to the layout parameter of the first control not needing to be set, the request for the layout parameter setting for the first control.

### CROSS-REFERENCE TO RELATED APPLICATION

This application claims priority to Chinese Application No. 202510571258.5 filed on Apr. 30, 2025, the disclosure of which is incorporated herein by reference in its entirety.

### FIELD

The present disclosure generally relates to the field of computers, and more particularly, to a method and apparatus for caching a layout parameter, device, computer-readable storage medium, and computer program product.

### BACKGROUND

In the current era of the deep popularization of the Internet, technology frameworks provide strong support for building display content of applications. The layout of a displayed control may be adjusted by using layout parameters. The layout parameters may precisely define attributes such as the size, position, and margin of the control, and the layout parameters may be used to adjust the display position, display size, and the like of the control in real time and flexibly.

For example, in the field of live streaming, the experience of interaction between a user and a streamer as well as other viewers is critical, and since a control is a carrier that undertakes business logic related to live streaming (for example, displaying key elements such as live streaming content and interaction information), the proper adjustment for the control plays an important role in improving the user experience. Whether the streamer needs to clearly present his or her image and explanation content, or the viewer expects to quickly obtain item details and participate in interactive discussions, both rely on efficient and flexible control setting technologies.

### SUMMARY

According to example embodiments of the present disclosure, a method and apparatus for caching a layout parameter, device, computer storage medium, and computer program product are provided.

In a first aspect of the present disclosure, a method for caching a layout parameter is provided, the method includes determining, in response to a request for a layout parameter setting for a first control, whether a layout parameter cache for the first control is present. The method further includes determining, in response to the layout parameter cache being present, whether the layout parameter of the first control needs to be set according to the layout parameter cache. The method further includes cancelling, in response to the layout parameter of the first control not needing to be set, the request for the layout parameter setting for the first control.

In a second aspect of the present disclosure, an apparatus for caching a layout parameter is provided, the apparatus includes a first determination module configured to determine, in response to a request for a layout parameter setting for a first control, whether a layout parameter cache for the first control is present. The apparatus further includes a second determination module configured to determine, in response to the layout parameter cache being present, whether the layout parameter of the first control needs to be set according to the layout parameter cache. The apparatus further includes a cancellation module configured to cancel, in response to the layout parameter of the first control not needing to be set, the request for the layout parameter setting for the first control.

In a third aspect of the present disclosure, an electronic device is provided, including at least one processing unit and at least one memory, where at least one memory is coupled to the at least one processing unit and stores instructions executable by the at least one processing unit, and the instructions, when executed by the at least one processing unit, causes the electronic device to perform the method described according to the first aspect of the present disclosure.

In a fourth aspect of the present disclosure, a computer-readable storage medium is provided, the computer-readable storage medium has machine-executable instructions stored thereon, the machine-executable instructions, when executed by a device, causes the device to perform the method described according to the first aspect of the present disclosure.

In a fifth aspect of the present disclosure, a computer program product is provided, including computer-executable instructions, the computer-executable instructions, when executed by a processor, implement the method described according to the first aspect of the present disclosure.

The Summary section is provided to introduce a series of concepts in a simplified form, which will be further described in the Detailed Description of Embodiment section below. The Summary section is not intended to identify key features or essential features of the present disclosure, nor is it intended to limit the scope of the present disclosure. Other features of the present disclosure will become readily understood through the following description.

### BRIEF DESCRIPTION OF THE DRAWINGS

FIG. 1 shows a schematic diagram of an example environment in which embodiments of the present disclosure may be implemented;

FIG. 2 shows a flowchart of a method for caching a layout parameter according to an embodiment of the present disclosure;

FIG. 3A shows a schematic diagram of a process for caching a layout parameter according to an embodiment of the present disclosure;

FIG. 3B shows a schematic diagram of the effect of the process for caching a layout parameter according to an embodiment of the present disclosure;

FIG. 4 shows a schematic diagram of a hierarchical structure of layout parameter caches according to an embodiment of the present disclosure;

FIG. 5 shows a schematic diagram of adapting a processing control according to an embodiment of the present disclosure;

FIG. 6 shows a schematic diagram of a process for caching a layout parameter according to an embodiment of the present disclosure;

FIG. 7 shows a schematic block diagram of an example apparatus according to some embodiments of the present disclosure; and

FIG. 8 shows a block diagram of an example device that may be used to implement an embodiment of the present disclosure.

Throughout the drawings, the same or similar reference numerals represent the same or similar elements.

### DETAILED DESCRIPTION OF EMBODIMENTS

The names of messages or information exchanged among a plurality of apparatuses in the implementations of the present disclosure are used for illustrative purposes only, and are not used to limit the scope of these messages or information. It may be understood that before using the technical solutions disclosed in the embodiments of the present disclosure, the user shall be informed of the type, range of use, use scenarios, etc. of personal information involved in the present disclosure and the authorization of the user shall be obtained in an appropriate manner in accordance with relevant laws and regulations.

For example, in response to receiving an active request from a user, prompt information is sent to the user to clearly inform the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure. As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other methods that satisfy relevant laws and regulations may also be applied to the implementations of the present disclosure.

The embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein; on the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term “include/comprise” and similar terms thereof should be understood as open-ended inclusions, that is, “include/comprise but not limited to”. The term “based on” should be understood as “at least partially based on”. The term “an embodiment” or “the embodiment” should be understood as “at least one embodiment”. The terms “first”, “second”, etc. may refer to different or same objects, unless explicitly stated. Other definitions, both explicit and implicit, may also be included below.

In general, when an application (App) is running, the display content may be switched between different states, which involves changing the layout of some controls. These changes may be achieved by setting the layout parameters of a certain control, such as setting the position of the control in the display interface, setting attributes such as the height and width of the control, or setting the weight of the control, etc. In order to ensure the timeliness and accuracy of display effects, operations such as calculating or measuring the size of the control in the image are required after setting the layout parameters, such as the width and height of the control. If there are multiple controls with an inheritance relationship in the image (such as a base control, a text control inheriting the base control, etc.), operations such as recalculating or remeasuring the size of these controls are required. This will consume a certain amount of computing resources. For example, in a live streaming scenario, the layout parameters of the control often need to be set frequently, so a large number of operations such as recalculating the size of the control usually occur. This leads to many unfavorable factors, such as the consumption of a lot of computing resources, overheating of mobile phones, and the occurrence of lag.

In this regard, the present disclosure proposes a method for caching a layout parameter. Before setting the layout parameters for the first control, the method determines the necessity of setting the layout parameters. First, it determines whether a layout parameter cache for the first control is present, and if the layout parameter cache is present, detects whether it is necessary to request the layout parameter setting according to the layout parameter cache. If it is determined that there is no need to request the layout parameter setting, the layout parameter setting is cancelled, thereby preventing the layout parameter of the first control from being set repeatedly, and preventing redundant operations such as remeasuring or recalculating the size of the control caused by the layout parameter setting, which may save computing resources, improve the fluency of the mobile phone, and reduce the overheating and the occurrence of lag.

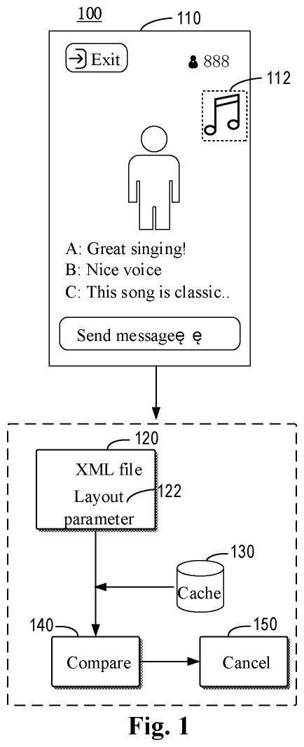

The embodiments of the present disclosure will be further described in detail below with reference to the drawings, where FIG. 1 shows a schematic diagram of an example environment 100 in which the embodiments of the present disclosure may be implemented. The example environment 100 includes a computing device 110. In this embodiment, a user may install an application on the computing device 110. By launching the application, the application may provide display content and business logic to the user by displaying images and controls therein. For example, the application may be a video application, and the user may open the video application on the computing device 110 and watch live streaming content. For example, the live streaming content shows the text information “Great singing!” of the interaction between a viewer and a streamer. The live streaming content may be provided with some controls, such as view controls such as text controls, to provide users with additional information and functions. For example, the live streaming content may be provided with a first control 112 indicating that the program type of the live streaming content belongs to the music type.

In some embodiments, the computing device 110 may set the layout parameter of the first control 112 in the live streaming content according to a code file, such as an extensible markup language (Extensible Markup Language, XML) file 120, in the process of playing the live streaming content. When switching between different states, the layout parameter 122 may be assigned a value in the code file and the layout parameter may be set. In some technology frameworks, the layout parameter setting may be achieved by the “setLayoutParams” function in some technology frameworks. In the embodiment of the present disclosure, the computing device 110 may add a cache 130 to detect in real time whether the request for the layout parameter setting for the first control 112 occurs or is triggered in the process of executing the code logic. In some embodiments, the first control 112 may store a pointer to the layout parameter to be set, and copy the data of the storage address pointed to by the pointer to the variable of the first control 112. When changing from one state to another, usually only the data of the pointer needs to be modified (for example, the pointer or variable is directly modified), and the modified data (that is, the layout parameter to be set) is set to the first control 112 by requesting a related function, thereby completing the layout parameter setting of the first control 112.

Different from the operation of remeasuring the size of the first control 112 every time the layout parameter setting is requested, in the embodiment of the present disclosure, the establishment of the layout parameter cache is used to terminate the redundant request to the layout parameter setting. In some embodiments, if the request for the layout parameter setting for the first control 112 occurs or is triggered, the computing device 110 may determine whether the layout parameter cache for the first control 112 is present in the cache 130. The computing device 110 may store the layout parameter cache at a specified storage address such as a memory. Storing the layout parameter cache in the memory may have a faster processing speed. If the computing device 110 does not pre-cache the layout parameter of the first control 112 before requesting the layout parameter setting for the first control 112, for example, there is no cache data in the cache 130, or the cache data in the cache 130 is null or inaccessible, it may be determined that the layout parameter cache for the first control 112 is not present. If the layout parameter cache for the first control 112 may be obtained or accessed in the cache 130, it may be determined that the layout parameter cache for the first control 112 is present.

In some embodiments, if the layout parameter cache in the cache 130 is present, the computing device 110 may determine whether the layout parameter of the first control 112 needs to be set according to the layout parameter cache. Here, the computing device 110 may detect the necessity of the request for the layout parameter setting. If the layout parameter cache for the first control 112 is the same as the layout parameter to be set, there is no need for the request. If the layout parameter cache is different from the layout parameter to be set, in order to ensure the accuracy of the display effect, it is necessary to request the layout parameter setting. In some embodiments, the computing device 110 may obtain the current layout parameter of the first control 112 from the cache 130 of the first control 112. In some embodiments, the computing device 110 may compare 140 the current layout parameter with the layout parameter cache to determine whether the layout parameter cache is the latest layout parameter. Only the layout parameter cache that reflects the latest layout parameter may be used to accurately determine the necessity.

In some embodiments, if there is no need to set the layout parameter of the first control 112, the computing device 110 may cancel (for example, terminate) 150 the request for the layout parameter setting for the first control 112. The cancellation operation may be the non-execution of any one of the steps for the entire process of the cache parameter setting, which may cause the entire process of setting the cache parameter to be terminated, and thus will not cause operations such as remeasuring the size of the control and requesting layout operation (such as requestLayout( ) operation), which may significantly reduce the waste of computing resources. Although some embodiments of the present disclosure take the live streaming scenario as an example, the present disclosure may also be applied to other scenarios that require the layout parameters setting of the first control.

The computing device 110 may be any type of mobile computing device, including a mobile computer (such as a personal digital assistant (PDA), a laptop computer, a notebook computer, a tablet computer, a netbook, etc.), a mobile phone (such as a cellular phone, a smart phone, etc.), a wearable computing device (such as a smart watch, a head-mounted device, including smart glasses, etc.), or other types of mobile devices. In some embodiments, the computing device 110 may also be a stationary computing device, such as a desktop computer, a game console, a smart TV, etc.

It should be understood that the architecture and functions in the example environment 100 are described for illustrative purposes only, without suggesting any limitation on the scope of the present disclosure. The embodiments of the present disclosure may also be applied to other environments with different structures and/or functions.

The process according to the embodiments of the present disclosure will be described in detail below with reference to other drawings. For ease of understanding, the specific data mentioned in the following description is exemplary and is not used to limit the protection scope of the present disclosure. It may be understood that the embodiments described below may further include additional actions not shown and/or may omit the actions shown, and the scope of the present disclosure is not limited in this regard.

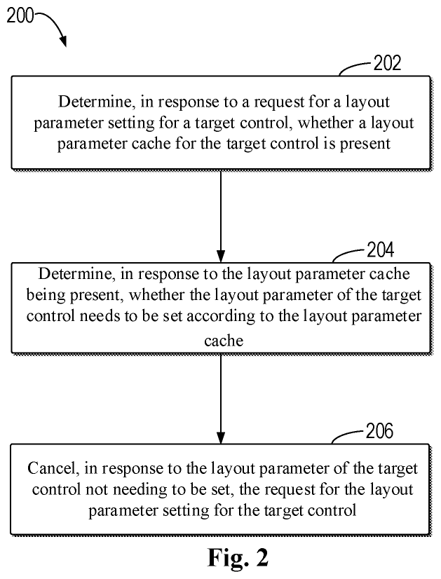

FIG. 2 shows a flowchart of a method 200 for caching a layout parameter according to some embodiments of the present disclosure. In this embodiment, the method may be executed by the computing device 110. At block 202, it is determined, in response to a request for a layout parameter setting for a first control, whether a layout parameter cache for the first control is present. The first control may include a user interface (UI) element for display, for example, a graphic identifier for identifying the program type of the live streaming content. In some embodiments, the first control may not only act as an identifier, but also include certain business logic for interacting with the user. In some embodiments, the first control includes an object (such as a button), and the layout parameter to be set is used to determine the position of the object.

In some embodiments, the layout parameter refers to a parameter related to the layout of the first control, such as parameters such as height, width, and left margin. For example, the layout parameter setting may be used for a first type of live streaming activity, which is associated with the first control. The first type of live streaming activity may be, for example, a live streaming activity initiated by a single streamer account. By setting the layout parameters, the layout of the first control may be adjusted in real time. As an example, it may be detected whether a layout parameter cache is present in a pre-specified buffer.

At block 204, it is determined, in response to the layout parameter cache being present, whether the layout parameter of the first control needs to be set according to the layout parameter cache. As an example, the layout parameter cache may be used as a basis for determining whether the layout parameter setting is required. For example, if the corresponding layout parameter cache is found, the cache data is further compared to determine whether the layout parameter to be set currently is consistent with the data in the cache, that is, whether it is really necessary to perform a new setting operation.

At block 206, the request for the layout parameter setting for the first control is cancelled in response to the layout parameter of the first control not needing to be set. If there is no need to set the layout parameter of the first control, it may be determined that this setting of the layout parameter is a redundant setting. At this time, this setting operation will be cancelled (for example, terminated) to avoid redundant size calculation or measurement operations caused thereby.

According to the method of the embodiment of the present disclosure, it is first determined whether the layout parameter cache of the first control is present, and if the layout parameter cache is present, it is detected whether it is necessary to request the layout parameter setting according to the content of the cache. If it is determined that there is no need to request, the setting operation is cancelled, thereby avoiding repeating the layout parameter setting of the first control, and preventing operations such as redundant setting of the control caused by the layout parameter setting, which may save computing resources, improve the fluency of the mobile phone, and reduce the overheating and the occurrence of lag.

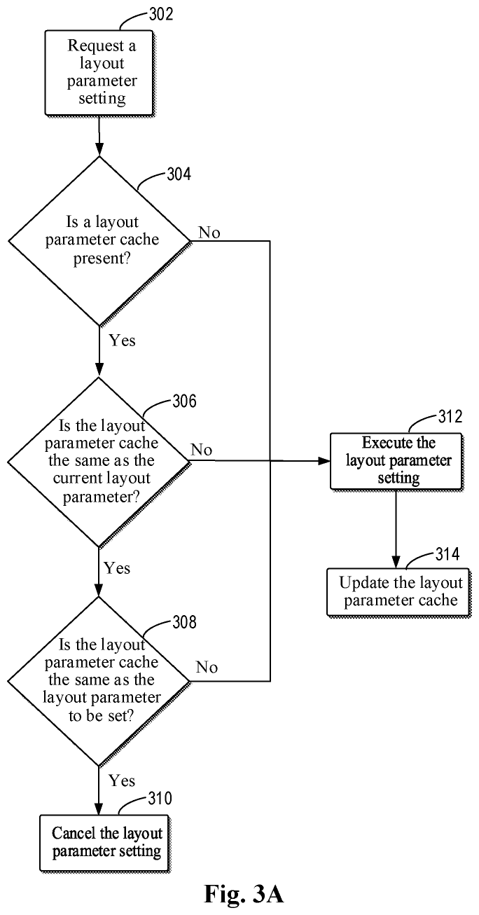

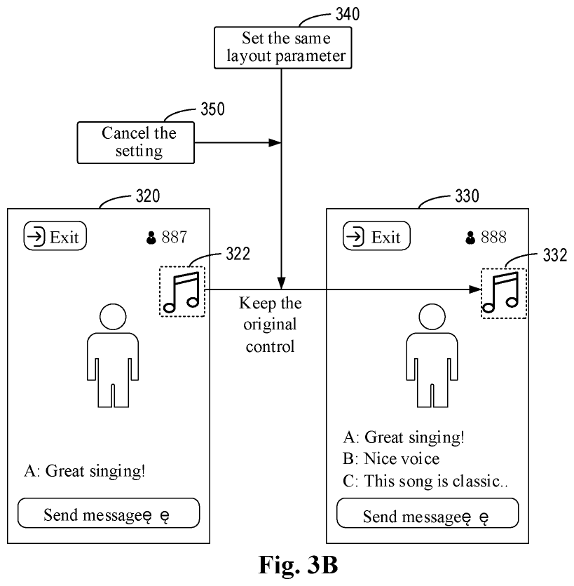

FIG. 3A shows a schematic diagram of a process for caching a layout parameter according to an embodiment of the present disclosure. At 302, it may be detected that the layout parameter setting is requested, and the method introduced in the above embodiment may be executed. At 304, it is determined whether a layout parameter cache is present. If there is the layout parameter cache is not present, there is no basis for analyzing the layout parameter setting, and the process proceeds to 312 to execute the layout parameter setting. In this way, the layout of the first control is adjusted according to the layout parameter to be set. At 314, the layout parameter to be set is cached to obtain the layout parameter cache. The next time the layout parameter setting is requested, the layout parameter cache may be used.

If the layout parameter cache is present, the process proceeds to block 306 to further determine whether the layout parameter cache is consistent with the current layout parameter. In some embodiments, if the layout parameter cache is present, the current layout parameter may be obtained via the first control. The first control usually stores a pointer to the layout parameter to be set (for example, stored through a single variable), and copies the data of the storage address pointed to by the pointer to a specific variable of the first control. In this way, when the first control is displayed, the layout parameter may no longer be repeatedly obtained from the storage address pointed to by the pointer, but the layout parameter may be directly read from the specific variable of the first control and displayed according to the layout parameter. Therefore, when it is detected that the layout parameter cache for the first control is already present, its current layout parameter (such as position, size, etc.) may be obtained from the first control itself.

Here, the current layout parameter of the first control may be obtained from one or more variables of the first control. Then it is compared whether the layout parameter cache is the same as the current layout parameter. In this embodiment, the layout parameter may not be a single layout parameter, but a layout parameter instance, for example, a “LayoutParams” instance in some technology frameworks. The layout parameter instance may include multiple attributes, and each attribute may be used to determine the layout of one aspect of the target component. For example, the layout parameter instance may include a width attribute, a height attribute, a gravity attribute, a weight attribute, a top margin attribute, and so on.

In some embodiments, there are multiple ways to compare whether the layout parameter cache is consistent with the current layout parameter. For example, when all the attributes of the layout parameter cache and all the attributes of the layout parameter to be set are the same, it is determined that the layout parameter cache is the same as the layout parameter to be set. Alternatively, when the specified attributes of the layout parameter cache and the specified attributes of the layout parameter to be set are all the same, it is determined that the layout parameter cache is the same as the layout parameter to be set, and so on. If the layout parameter cache is different from the current layout parameter, the process proceeds to block 312, and if the layout parameter cache is different from the current layout parameter, it is determined that the layout parameter of the first control needs to be set, and therefore the layout parameter setting is executed to modify the layout parameter of the first control. The process then proceeds to block 314 to update the layout parameter cache with the layout parameter to be set. Because different layout parameters mean that the current layout of the target component is not the desired layout and needs to be set. Since the layout parameter of the first control may be modified in various ways, and these modifications are not necessarily updated to the layout parameter cache in a timely manner, the layout parameter cache may not necessarily conform to the current layout parameter of the first control. By comparing whether the layout parameter cache is the same as the current layout parameter, it may be ensured that in the case where the layout parameter cache reflects the current layout of the first control, whether the request for the layout parameter setting needs to be cancelled is determined, which may improve the accuracy of cancelling the request for the layout parameter setting.

If the layout parameter cache is the same as the current layout parameter, the process proceeds to block 308. If the layout parameter cache is the same as the current layout parameter, it is determined whether the layout parameter of the first control needs to be set according to the layout parameter cache and the layout parameter to be set, where the layout parameter to be set is the layout parameter to be passed into the layout parameter setting. In some embodiments, the layout parameter cache includes a width attribute and a height attribute, and the layout parameter to be set also includes a width attribute and a height attribute. In some embodiments, whether the width attribute and the height attribute of the layout parameter cache are the same as the width attribute and the height attribute of the layout parameter to be set is compared one by one. In some embodiments, if the width attribute and the height attribute of the layout parameter cache are the same as the width attribute and the height attribute of the layout parameter to be set respectively, it is determined that the layout parameter cache is the same as the layout parameter to be set. In some embodiments, if at least one attribute of the layout parameter cache is different from the corresponding attribute of the layout parameter to be set, it is determined that the layout parameter cache is different from the layout parameter to be set.

If it is determined that the layout parameter cache is the same as the layout parameter to be set, the setting operation is cancelled at block 310 to avoid unnecessary consumption of computing resources and potential performance loss. The layout parameter cache being the same as the layout parameter to be set indicates that this setting of the layout parameter is a redundant setting, so there is no need to perform the setting, thereby avoiding unnecessary consumption of computing resources and potential performance loss. Otherwise, the layout parameter setting is executed at block 312 to modify the layout parameter of the first control. The process then proceeds to block 314 to update the layout parameter cache with the layout parameter to be set. After setting the layout parameter of the first control, the display of the first control may be changed as expected to meet the purpose of the layout parameter setting. In this embodiment, by using the layout parameter cache to compare the current layout parameter and the layout parameter to be set respectively, the necessity of requesting the layout parameter setting may be determined more accurately, thereby reducing redundant setting operations and subsequent operations such as remeasuring the size.

FIG. 3B shows a schematic diagram of the effect of the process for caching a layout parameter according to the embodiment of the present disclosure. At block 340, when switching between different states, the same layout parameter as the layout parameter cache may be set. For example, the layout parameter to be set is for the first control 322 of the live streaming content 320, and the first control 322 may be used to identify that the program category of the live streaming content 320 is the music category, and its size and position are as shown in the figure. In some embodiments, if there is a switch from a first type of live streaming activity associated with the first control (such as a live streaming activity initiated by a single streamer account) to a second type of live streaming activity associated with the first control, it may be determined that there is a request for the layout parameter setting for the first control. The second type of live streaming activity may be, for example, a joint live streaming activity involving multiple streamer accounts. Since the joint live streaming activity involves multiple streamer accounts, when switching from the live streaming activity initiated by a single streamer account to the joint live streaming activity, the display interface needs to be adjusted, so there will be a request for the layout parameter setting for the first control, which may be used as an example of the triggering timing in the embodiment of the present disclosure.

At block 350, the computing device 110 detects that the layout parameter cache is the same as the layout parameter to be set, and cancels the setting operation, which results in the first control 332 of the live streaming content 330 maintaining the previous layout parameter, for example, attributes such as the width and the height remain unchanged. Moreover, there is no need to perform other operations related to the layout parameter setting for the first control 332, such as remeasuring the size of the control, requesting layout operation, etc., which may reduce the waste of computing resources.

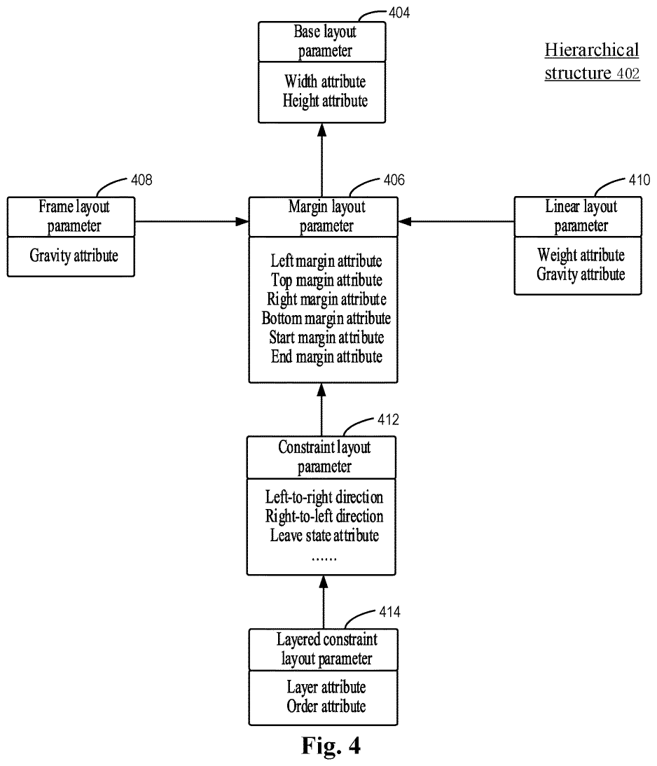

In some technology frameworks, the layout parameter may have a complex hierarchical structure. FIG. 4 shows a schematic diagram of a hierarchical structure of a layout parameter cache according to an embodiment of the present disclosure. In order to ensure that the layout parameter cache may be compared with the layout parameter to be set, the hierarchical structure 402 of the layout parameter cache may be determined with reference to the hierarchical structure of the layout parameter to be set.

In this embodiment, the base class of the hierarchical structure 402 is a base layout parameter 404, which includes at least a width attribute and a height attribute. The subclass directly inherited from the base layout parameter 404 is a margin layout parameter 406, which includes at least a left margin attribute, a top margin attribute, a right margin attribute, a top margin attribute, a start margin attribute, and an end margin attribute. The subclasses directly inherited from the base layout parameter 406 include a frame layout parameter 408, a linear layout parameter 410, and a constraint layout parameter 412. The frame layout parameter 408 includes at least a gravity attribute. The linear layout parameter 410 includes at least a weight attribute and a gravity attribute. The constraint layout parameter 412 includes at least an attribute indicating a left-to-right direction, an attribute indicating a right-to-left direction, and a leave state attribute. The subclass inherited from the constraint layout parameter 412 includes a layered constraint layout parameter 414, which includes a layer attribute and an order attribute.

In some technology frameworks, for the layout parameter to be set, it is allowed to define a layout parameter category on the basis of the existing hierarchical structure and set these layout parameters in the layout parameter to be set. Accordingly, the layout parameter cache may have a corresponding custom layout parameter category. For example, a certain layout parameter category may be customized, which inherits the linear layout parameter 410. In this way, all the data of the layout parameter may be cached, and the accuracy of determining whether it is necessary to request the layout parameter setting may be improved.

Because of such a complex hierarchical structure, the layout parameter cache will occupy a certain amount of storage space. In practice, even in a live streaming scenario, not every control will be adjusted frequently. In this regard, in some embodiments, a number of requests to the layout parameter setting for the first control is determined. For example, the layout parameter setting is counted, and each time the setting is requested, the number of requests increases by one. In some embodiments, if the number of requests is greater than a threshold, the layout parameter cache is updated according to the layout parameter to be set. For example, the threshold may be set to 2, so that the method for caching a layout parameter according to the embodiments of the present disclosure is executed from the third request. This may significantly reduce the storage resources occupied.

When setting the layout parameter in some technology frameworks, different processing controls may be selected for the category of the layout parameter, including but not limited to a view processing control, a frame layout (FrameLayout) processing control, etc. Since the processing logic for the request for the layout parameter setting has changed, the processing controls may be adapted accordingly, and appropriate processing controls may be selected according to the layout parameter categories. In some embodiments, when the layout parameter setting for the first control is requested, the layout parameter category of the layout parameter to be set is determined. In this embodiment, the processing controls in each technology framework are adapted according to the category of the layout parameter, which conforms to general usage habits. In some embodiments, the first processing control is determined according to the layout parameter category. The first processing control is a space such as the above-mentioned view processing control. In some embodiments, the second processing control is determined according to the first processing control. In some embodiments, the second processing control is used to determine whether the layout parameter cache for the first control is present.

In this embodiment, after the adaptation of the processing controls, each processing control may implement the method for caching a layout parameter disclosed in the above embodiments for the layout parameter of its own type, for example, to implement the comparison of layout parameters. In some technology frameworks, the second processing control includes at least one of a view processing control, a frame layout (FrameLayout) processing control, a linear layout (LinearLayout) processing control, a constraint layout (ContraintLayout) processing control, and a relative layout (RelativeLayout) processing control.

Table 1 shows the first processing control and the adapted processing control.

| Source control | Adapted processing control |
|---|---|
| View | LPO View |
| FrameLayout | LPO FrameLayout |
| LinearLayout | LPO LinearLayout |
| ConstraintLayout | LPO ConstraintLayout |
| RelativeLayout | LPO RelativeLayout |
| ImageView/compatible image view | LPO ImageView |
| CardView | LPO CardView |
| AnimationView | LPO AnimationView |

The first processing control and the adapted processing control in Table 1 are examples, and different processing controls may be used according to different technology frameworks.

In some embodiments, when the layout parameter setting for the first control is requested, the processing control may determine a service, and the service is used to determine the first control. For example, in some technology frameworks, the service may be used to generate first controls compatible with different versions of technology frameworks. In some embodiments, a constructor is determined according to the service. The constructor is used to convert an XML file into a first control instance.

In some embodiments, it is determined whether the constructor has an interface. The interface allows intervention in the process of converting the XML file into the first control instance. In some embodiments, if the constructor has the interface, the layout parameter category of the layout parameter to be set is determined by using the interface. In the interface, the method disclosed in the above embodiments may be accessed in the form of code, thereby realizing the adaptation of the processing control.

In this embodiment, the original service, base class or method in the technology framework is used to implement the adaptation of the processing control. This adaptation method does not require adjusting each control in the technology framework one by one (which leads to a larger modification amplitude of the technology framework), and has a lower modification scale, thereby having lower maintenance costs and fewer business risks.

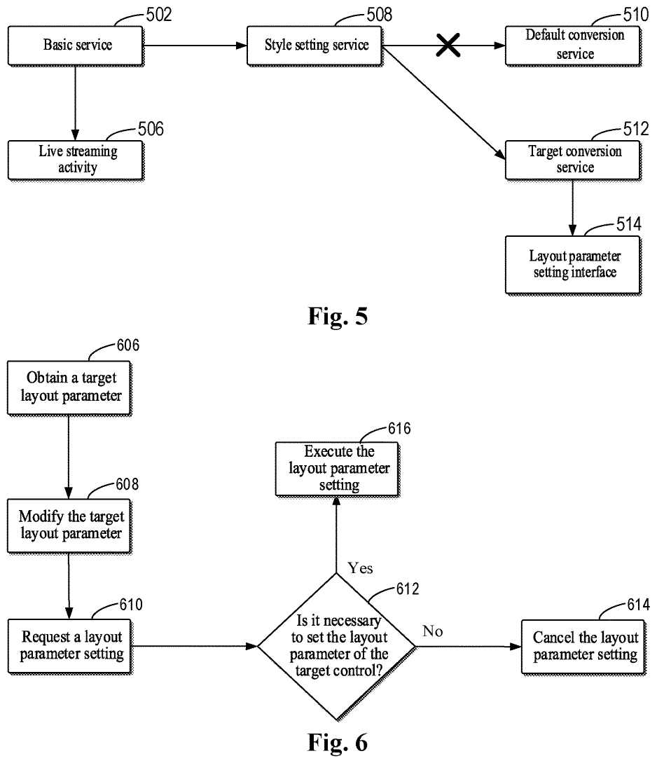

FIG. 5 shows a schematic diagram of adapting a processing control according to an embodiment of the present disclosure. In this embodiment, a layout parameter is set for a first type of live streaming activity 506, and the first type of live streaming activity 506 is associated with a first control. The first type of live streaming activity 506 may inherit a basic service (or a base class) 502 in a technology framework, so that the first type of live streaming activity 506 has various specific services (such as various functions or methods) provided by the basic service 502. The basic service 502 may include a style setting service 508, which is used to generate a first control compatible with different versions of technology frameworks. The style setting service 508 has a default conversion service 510 for converting an XML file into the first control in a default conversion mode.

In this embodiment, a target conversion service 512 is used to replace the default conversion service 510. The target conversion service 512 may adjust the default conversion mode, for example, detect the request for the layout parameter setting. The target conversion service 512 may be provided with a layout parameter setting interface 514, and the layout parameter setting interface 514 is used to load the method for caching a layout parameter disclosed in the above embodiments. In this way, a specific category of processing control may process the request for the layout parameter setting involving the corresponding category. For example, if the layout parameter setting interface 514 determines to use the LPO View processing control to implement the above embodiment according to the mapping relationship in Table 1, the LPO View processing control may be used to determine whether a layout parameter cache for the first control is present in response to the request for the layout parameter setting for the first control. In response to the layout parameter cache being present, the LPO View processing control may be used to determine whether the layout parameter of the first control needs to be set according to the layout parameter cache. In response to the fact that there is no need to set the layout parameter of the first control, the LPO View processing control may be used to cancel the request for the layout parameter setting for the first control.

FIG. 6 shows a schematic diagram of a process for caching a layout parameter according to an embodiment of the present disclosure. As described above, the target component may store a pointer to a layout parameter to be set during the display process. In this embodiment, the target layout parameter may be obtained at block 606. The acquisition here may be a reference to the pointer pointing to the target layout parameter. At block 608, the modification of the layout parameter may be achieved by modifying the value of the target layout parameter. If the modified data (that is, the layout parameter to be set) is not set to the first control by requesting a related function after the value of the layout parameter is modified, the first control maintains the layout parameter copied or cached by itself. At block 610, the layout parameter setting may be requested. When the layout parameter setting is requested, the layout parameter setting is not directly executed, but at block 612, whether the layout parameter of the target framework needs to be set is determined according to the above-mentioned method for caching a layout parameter. If there is no need to set the layout parameter, the layout parameter setting is cancelled at block 614. If the layout parameter needs to be set, the layout parameter setting is executed at block 616.

In this embodiment, the data of the pointer may be directly modified (for example, an assignment operation is directly performed on the layout parameter pointed to by the pointer), and the related function is requested to set the modified data (that is, the layout parameter to be set) to the first control, thereby completing the layout parameter setting of the first control, without considering whether the target layout parameter is the same as the layout parameter before the modification. Because if they are the same, the layout parameter setting may be cancelled, which will not lead to redundant requests. Therefore, this may improve the programming efficiency.

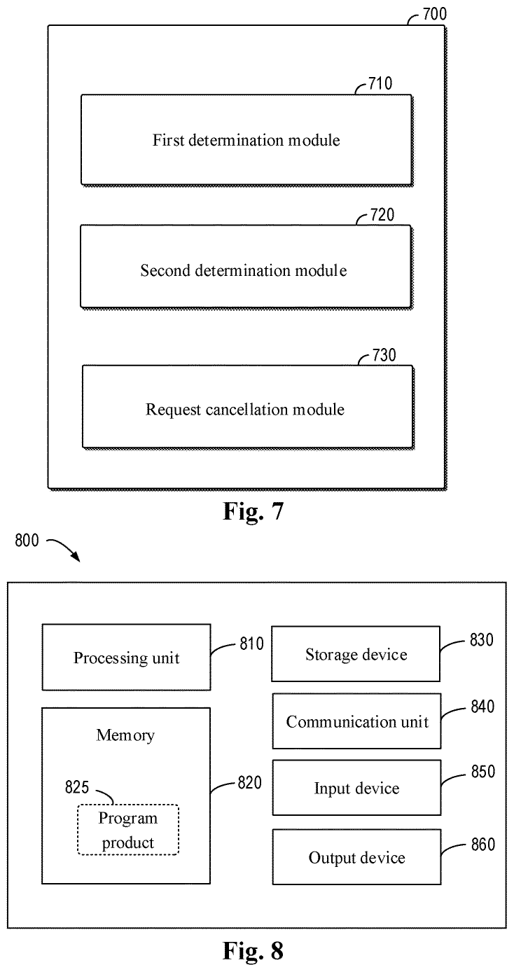

FIG. 7 shows a schematic block diagram of an example apparatus 700 according to some embodiments of the present disclosure. The apparatus 700 may be implemented by software, hardware, or a combination thereof. As shown in FIG. 7, the apparatus 700 includes a first determination module 710, a second determination module 720, and a request cancellation module 730.

In some embodiments, the first determination module 710 may be configured to determine, in response to a request for a layout parameter setting for a first control, whether a layout parameter cache for the first control is present. The second determination module 720 may be configured to determine, in response to the layout parameter cache being present, whether the layout parameter of the first control needs to be set according to the layout parameter cache. The request cancellation module 730 may be configured to cancel, in response to the layout parameter of the first control not needing to be set, the request for the layout parameter setting for the first control.

In some embodiments, the second determination module 720 includes an acquisition module configured to acquire, in response to the layout parameter cache being present, a current layout parameter via the first control. The second determination module 720 further includes a first comparison module configured to determine whether the layout parameter cache is the same as the current layout parameter. The second determination module 720 further includes a third determination module configured to determine, in response to the layout parameter cache being different from the current layout parameter, that the layout parameter of the first control needs to be set. The second determination module 720 further includes a fourth determination module configured to determine, in response to the layout parameter cache being the same as the current layout parameter, whether the layout parameter of the first control needs to be set according to the layout parameter cache and a layout parameter to be set, where the layout parameter to be set is a layout parameter to be passed into the layout parameter setting.

In some embodiments, the fourth determination module includes a second comparison module configured to determine, in response to the layout parameter cache being the same as the current layout parameter, whether the layout parameter cache is the same as the layout parameter to be set. The fourth determination module further includes a fifth determination module configured to determine, in response to the layout parameter cache being different from the layout parameter to be set, that the layout parameter of the first control needs to be set. The fourth determination module further includes a sixth determination module configured to determine, in response to the layout parameter cache being the same as the layout parameter to be set, that there is no need to set the layout parameter of the first control.

In some embodiments, the layout parameter cache includes a width attribute and a height attribute, the layout parameter to be set also includes a width attribute and a height attribute, and the second comparison module includes a third comparison module configured to compare whether the width attribute and the height attribute of the layout parameter cache are the same as the width attribute and the height attribute of the layout parameter to be set one by one. The second comparison module further includes a seventh determination module configured to determine, in response to the width attribute and the height attribute of the layout parameter cache being the same as the width attribute and the height attribute of the layout parameter to be set respectively, that the layout parameter cache is the same as the layout parameter to be set. The second comparison module further includes an eighth determination module configured to determine, in response to at least one attribute of the layout parameter cache being different from a corresponding attribute of the layout parameter to be set, that the layout parameter cache is different from the layout parameter to be set.

In some embodiments, the apparatus 700 further includes an execution module configured to set the layout parameter of the first control by the layout parameter setting in response to the layout parameter of the first control needing to be set. The apparatus 700 further includes an update module configured to update the layout parameter cache according to the layout parameter to be set.

In some embodiments, the update module includes a request number determination module configured to determine a number of requests to the layout parameter setting for the first control. The update module further includes a sub-update module configured to update, in response to the number of requests being greater than a threshold, the layout parameter cache according to the layout parameter to be set.

In some embodiments, the first determination module 710 includes a ninth determination module configured to determine, in response to the request for the layout parameter setting for the first control, a layout parameter category of the layout parameter to be set. The first determination module 710 includes a tenth determination module configured to determine a first processing control according to the layout parameter category. The first determination module 710 includes a mapping module configured to determine a second processing control according to the first processing control. The first determination module 710 includes an eleventh determination module configured to determine, using the second processing control, whether the layout parameter cache for the first control is present.

In some embodiments, the ninth determination module includes a twelfth determination module configured to determine, in response to the request for the layout parameter setting for the first control, a target service, the target service being used to determine the first control. The ninth determination module further includes a thirteenth determination module configured to determine a constructor according to the target service. The ninth determination module further includes a fourteenth determination module configured to determine whether the constructor has an interface. The ninth determination module further includes a fifteenth determination module configured to determine, in response to the constructor having the interface, a layout parameter category of the layout parameter to be set using the interface.

In some embodiments, the processing control includes at least one of a target view processing control, a frame layout processing control, a linear layout processing control, a constraint layout processing control, and a relative layout processing control.

In some embodiments, the layout parameter setting is used for a first type of live streaming activity, and the first type of live streaming activity is associated with the first control.

In some embodiments, the apparatus 700 further includes a sixteenth determination module configured to determine, in response to a switch from the first type of live streaming activity to a second type of live streaming activity, that the request for the layout parameter setting for the first control is present, the second type of live streaming activity being associated with the first control.

In some embodiments, the first control includes an object, and the layout parameter to be set is used to determine a position of the object.

The division of modules or units in the embodiments of the present disclosure is schematic, which is only a logical function division, and may be divided by other ways in the actual implementation. In addition, the functional units in the disclosed embodiments may be integrated in one unit, each unit may also exist physically alone, or two or more units may be integrated into one unit. The above integrated units may be implemented in the form of hardware or in the form of software functional units.

FIG. 8 shows a block diagram of an example device 800 that may be used to implement the embodiments of the present disclosure. It should be understood that the device 800 shown in FIG. 8 is only an example, and should not constitute any limitation on the function and scope of the implementations described herein. For example, the device 800 may correspond to the computing device 110 described herein with reference to FIG. 1, and may be used to perform the processes of FIG. 1 to FIG. 6 described above.

As shown in FIG. 8, the device 800 is in the form of a general computing device. The components of the computing device 800 may include, but are not limited to, one or more processors or processing units 810, a memory 820, a storage device 830, one or more communication units 840, one or more input devices 850, and one or more output devices 860. The processing unit 810 may be an actual or virtual processor and may execute various processes based on the programs stored in the memory 820. In a multi-processor system, multiple processing units execute computer-executable instructions in parallel to improve the parallel processing capability of the computing device 800.

The computing device 800 typically includes multiple computer storage medium. Such medium may be any available medium that is accessible to the computing device 800, including but not limited to volatile and non-volatile medium, removable and non-removable medium. The memory 820 may be a volatile memory (for example, a register, a cache, a random access memory (Random Access Memory, RAM)), a non-volatile memory (such as a read-only memory (Read Only Memory, ROM), an electrically erasable programmable read-only memory (Electrically Erasable Programmable Read Only Memory, EEPROM), a flash memory), or any combination thereof. The storage device 830 may be a removable or non-removable medium, and may include a machine-readable medium such as a flash drive, a disk, or any other medium, which may be used to store information and/or data (such as training data for training) and may be accessed within the computing device 800.

The computing device 800 may further include additional removable/non-removable, volatile/non-volatile storage medium. Although not shown in FIG. 8, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 820 may include a computer program product 825, which has one or more program modules configured to perform various methods or acts of various implementations of the present disclosure.

The communication unit 840 enables communication with other computing devices through a communication medium. Additionally, the functions of the components of the computing device 800 may be implemented by a single computing cluster or multiple computing machines, which may communicate through communication connections. Therefore, the computing device 800 may use a logical connection with one or more other servers, a network personal computer (PC), or another network node to operate in a networked environment.

The input device 850 may be one or more input devices, such as a mouse, a keyboard, a tracking ball, etc. The output device 860 may be one or more output devices, such as a display, a speaker, a printer, etc. The computing device 800 may further communicate with one or more external devices (not shown) through the communication unit 840 as needed, the external devices such as a storage device, a display device, etc., communicate with one or more devices that enable the user to interact with the computing device 800, or communicate with any devices (such as a network card, a modem, etc.) that enable the computing device 800 to communicate with one or more other computing devices. Such communication may be performed via an input/output (I/O) interface (not shown).

According to an example implementation of the present disclosure, there is provided a computer-readable storage medium having computer-executable instructions stored thereon, the computer-executable instructions being executed by a processor to implement the method described above. According to an example implementation of the present disclosure, there is further provided a computer program product tangibly stored on a non-transitory computer-readable medium and including computer-executable instructions, the computer-executable instructions being executed by a processor to implement the method described above. According to an example implementation of the present disclosure, there is provided a computer program product having a computer program stored thereon, the program, when executed by a processor, implements the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowchart and/or block diagram, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus that implements the functions/acts specified in one or more blocks of the flowchart and/or block diagram. These computer-readable program instructions may also be stored in a computer-readable storage medium, these instructions cause the computer, the programmable data processing apparatus, and/or other devices to work in a specific way, and thus, the computer-readable medium storing the instructions includes a manufactured product, which includes instructions for implementing various aspects of the functions/acts specified in one or more blocks of the flowchart and/or block diagram.

The computer-readable program instructions may be loaded onto a computer, another programmable data processing apparatus, or other devices, causing a series of operations and steps to be performed on the computer, another programmable data processing apparatus, or other devices to produce a computer-implemented process, such that the instructions executed on the computer, another programmable data processing apparatus, or other devices implement the functions/acts specified in one or more blocks of the flowchart and/or block diagram.

The flowchart and block diagram in the drawings show the possibly implemented architectures, functions, and operations of the system, the method, and the computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart, may be implemented by a special-purpose hardware-based system that executes specified functions or acts, or may be implemented by a combination of special-purpose hardware and computer instructions.

The implementations of the present disclosure have been described above, and the above description is exemplary, non-exhaustive, and not limited to the disclosed implementations. Without departing from the scope and spirit of the illustrated implementations, many modifications and changes will be apparent to those of ordinary skill in the art. The choice of terms used herein is intended to best explain the principles, practical applications, or improvements to the technology in the market of each implementation, or to enable other ordinary skilled in the art to understand the various implementations disclosed herein.

I/We claim:

1. A method for caching a layout parameter, comprising:
determining, in response to a request for a layout parameter setting for a first control, whether a layout parameter cache for the first control is present;
determining, in response to the layout parameter cache being present, whether the layout parameter of the first control needs to be set according to the layout parameter cache; and
cancelling, in response to the layout parameter of the first control not needing to be set, the request for the layout parameter setting for the first control.

2. The method of claim 1, wherein determining, in response to the layout parameter cache being present, whether the layout parameter of the first control needs to be set according to the layout parameter cache comprises:
acquiring, in response to the layout parameter cache being present, a current layout parameter via the first control;
determining whether the layout parameter cache is the same as the current layout parameter;
determining, in response to the layout parameter cache being different from the current layout parameter, that the layout parameter of the first control needs to be set; and
determining, in response to the layout parameter cache being the same as the current layout parameter, whether the layout parameter of the first control needs to be set according to the layout parameter cache and a layout parameter to be set, the layout parameter to be set being a layout parameter to be passed into the layout parameter setting.

3. The method of claim 2, wherein determining, in response to the layout parameter cache being the same as the current layout parameter, whether the layout parameter of the first control needs to be set according to the layout parameter cache and the layout parameter to be set comprises:
determining, in response to the layout parameter cache being the same as the current layout parameter, whether the layout parameter cache is the same as the layout parameter to be set;
determining, in response to the layout parameter cache being different from the layout parameter to be set, that the layout parameter of the first control needs to be set; and
determining, in response to the layout parameter cache being the same as the layout parameter to be set, that the layout parameter of the first control does not need to be set.

4. The method of claim 3, wherein the layout parameter cache comprises a width attribute and a height attribute, the layout parameter to be set also comprises a width attribute and a height attribute, and determining whether the layout parameter cache is the same as the layout parameter to be set comprises:
comparing whether the width attribute and the height attribute of the layout parameter cache are the same as the width attribute and the height attribute of the layout parameter to be set one by one;
determining, in response to the width attribute and the height attribute of the layout parameter cache being the same as the width attribute and the height attribute of the layout parameter to be set respectively, that the layout parameter cache is the same as the layout parameter to be set; and
determining, in response to at least one attribute of the layout parameter cache being different from a corresponding attribute of the layout parameter to be set, that the layout parameter cache is different from the layout parameter to be set.

5. The method of claim 4, further comprising:
setting the layout parameter of the first control by the layout parameter setting in response to the layout parameter of the first control needing to be set; and
updating the layout parameter cache according to the layout parameter to be set.

6. The method of claim 5, wherein updating the layout parameter cache according to the layout parameter to be set comprises:
determining a number of requests to the layout parameter setting for the first control; and
updating, in response to the number of requests being greater than a threshold, the layout parameter cache according to the layout parameter to be set.

7. The method of claim 1, wherein determining, in response to the request for the layout parameter setting for the first control, whether the layout parameter cache for the first control is present comprises:
determining, in response to the request for the layout parameter setting for the first control, a layout parameter category of the layout parameter to be set;
determining a first processing control according to the layout parameter category;
determining a second processing control according to the first processing control; and
determining, using the second processing control, whether the layout parameter cache for the first control is present.

8. The method of claim 7, wherein determining, in response to the request for the layout parameter setting for the first control, the layout parameter category of the layout parameter to be set comprises:
determining, in response to the request for the layout parameter setting for the first control, a service configured to determine the first control;
determining a constructor according to the service;
determining whether the constructor has an interface; and
determining, in response to the constructor having the interface, the layout parameter category of the layout parameter to be set using the interface.

9. The method of claim 8, wherein the second processing control comprises at least one of a view processing control, a frame layout processing control, a linear layout processing control, a constraint layout processing control, and a relative layout processing control.

10. The method of claim 1, wherein the layout parameter setting is configured for a first type of live streaming activity, and the first type of live streaming activity is associated with the first control.

11. The method of claim 10, further comprising:
determining, in response to a switch from the first type of live streaming activity to a second type of live streaming activity, that the request for the layout parameter setting for the first control is present, wherein the second type of live streaming activity is associated with the first control.

12. The method of claim 10, wherein the first control comprises an object, and the layout parameter to be set is used to determine a position of the object.

13. An electronic device, comprising:
at least one processing unit; and
at least one memory, wherein the at least one memory is coupled to the at least one processing unit and stores instructions executable by the at least one processing unit, and the instructions, when executed by the at least one processing unit, causes the electronic device to:
determine, in response to a request for a layout parameter setting for a first control, whether a layout parameter cache for the first control is present;
determine, in response to the layout parameter cache being present, whether the layout parameter of the first control needs to be set according to the layout parameter cache; and
cancel, in response to the layout parameter of the first control not needing to be set, the request for the layout parameter setting for the first control.

14. The electronic device of claim 13, wherein the instructions further cause the electronic device to:
acquire, in response to the layout parameter cache being present, a current layout parameter via the first control;
determine whether the layout parameter cache is the same as the current layout parameter;
determine, in response to the layout parameter cache being different from the current layout parameter, that the layout parameter of the first control needs to be set; and
determine, in response to the layout parameter cache being the same as the current layout parameter, whether the layout parameter of the first control needs to be set according to the layout parameter cache and a layout parameter to be set, the layout parameter to be set being a layout parameter to be passed into the layout parameter setting.

15. The electronic device of claim 14, wherein the instructions further cause the electronic device to:
determine, in response to the layout parameter cache being the same as the current layout parameter, whether the layout parameter cache is the same as the layout parameter to be set;
determine, in response to the layout parameter cache being different from the layout parameter to be set, that the layout parameter of the first control needs to be set; and
determine, in response to the layout parameter cache being the same as the layout parameter to be set, that the layout parameter of the first control does not need to be set.

16. The electronic device of claim 15, wherein the layout parameter cache comprises a width attribute and a height attribute, the layout parameter to be set also comprises a width attribute and a height attribute, and wherein the instructions further cause the electronic device to:
compare whether the width attribute and the height attribute of the layout parameter cache are the same as the width attribute and the height attribute of the layout parameter to be set one by one;
determine, in response to the width attribute and the height attribute of the layout parameter cache being the same as the width attribute and the height attribute of the layout parameter to be set respectively, that the layout parameter cache is the same as the layout parameter to be set; and
determine, in response to at least one attribute of the layout parameter cache being different from a corresponding attribute of the layout parameter to be set, that the layout parameter cache is different from the layout parameter to be set.

17. The electronic device of claim 16, wherein the instructions further cause the electronic device to:
set the layout parameter of the first control by the layout parameter setting in response to the layout parameter of the first control needing to be set; and
update the layout parameter cache according to the layout parameter to be set.

18. The electronic device of claim 17, wherein the instructions further cause the electronic device to:
determine a number of requests to the layout parameter setting for the first control; and
update, in response to the number of requests being greater than a threshold, the layout parameter cache according to the layout parameter to be set.

19. The electronic device of claim 13, wherein the instructions further cause the electronic device to:
determine, in response to the request for the layout parameter setting for the first control, a layout parameter category of the layout parameter to be set;
determine a first processing control according to the layout parameter category;
determine a second processing control according to the first processing control; and
determine, using the second processing control, whether the layout parameter cache for the first control is present.

20. A non-transitory computer-readable storage medium having machine-executable instructions stored thereon, wherein the machine-executable instructions, when executed by a device, causes the device to:
determine, in response to a request for a layout parameter setting for a first control, whether a layout parameter cache for the first control is present;
determine, in response to the layout parameter cache being present, whether the layout parameter of the first control needs to be set according to the layout parameter cache; and
cancel, in response to the layout parameter of the first control not needing to be set, the request for the layout parameter setting for the first control.
